(19) United States
(12) Patent Application Publication
(10) Pub. No.: US 2016/0084138 A1
(43) Pub. Date: Mar. 24, 2016

(54) DUAL LAYER EXHAUST TIP

(71) Applicant: Mitchell Wayne Ferguson, Parkersburg, WV (US)

(72) Inventor: Mitchell Wayne Ferguson, Parkersburg, WV (US)

(21) Appl. No.: 14/864,548

(22) Filed: Sep. 24, 2015

Related U.S. Application Data
(60) Provisional application No. 62/054,681, filed on Sep. 24, 2014.

(51) Int. Cl. F01N 13/08; F01N 13/18; F16L 9/19; F01N 13/20

(52) U.S. Cl. CPC F01N 13/082; F01N 13/20; F01N 13/1805; F16L 9/19

(57) ABSTRACT

The present invention is a exhaust tip that is constructed of an inner and an outer cylindrical structure and ventilated such that decorative artwork located on the outer cylindrical structure is not damaged by heat generated by exhaust gasses flowing through the exhaust tip.

### CROSS-REFERENCE TO RELATED APPLICATION

This application claims priority to provisional application 62/054681 filed on Sep. 24, 2014 and is incorporated by reference in its entirety as if fully recited herein.

### TECHNICAL FIELD

Exemplary embodiments of the present invention relate generally to an automotive accessory for use in vehicle exhaust systems.

### BACKGROUND AND SUMMARY OF THE INVENTION

Owners and operators of motor vehicles frequently take a great deal of pride in their vehicles. One way that such owners show this pride is to improve or customize the appearance of their vehicles. In addition to well known vehicle customizations such as exterior body panels, paint, engine, and drive train components, certain owners may wish to customize the appearance of their exhaust system. Frequently this customization takes the form of a decorative tip that may be affixed to the outlet of an existing exhaust system. Known embodiments of such decorative tips are chrome plated metal or heat resistant paint. Heat resistant paints are available in only a limited number of colors. Further customization of the color of such tips to add graphic details such as simulated flames may be cost prohibitive and subject to damage due to the heat generated by exhaust gasses. Despite such cost and risk of damage due to heat, many owners and operators seeking to customize their vehicle desire decorative exhaust tips with details beyond chrome plating or simple heat resistive black paint. What is needed is a exhaust tip that permits the use of low temperature decorative elements such as low temperature paint or vinyl overlay materials that may be formed with decorative patterns and colors. In an embodiment of the invention, an exhaust tip that may be affixed to an automotive, truck, or marine exhaust system may be formed from an inner and outer cylindrical structure where the outer structure is configured with openings that allow cool air to be draw into the space between the inner and outer cylindrical structures. An open end of each such cylindrical structures are arranged to cause the exit of exhaust gas from the inner structure to draw cool air across the inner surface of the outer cylindrical structure such that the outer structure remains at a temperature sufficiently low as to not damage the paint or vinyl overlay on the exterior cylindrical structure.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a side view of an embodiment of the invention;

FIG. 2 is a diagram of the exhaust and cooling air flow through the invention;

FIG. 3 is an end view illustrating the outlet portion of an embodiment of the invention;

FIG. 4 is an end view illustrating the inlet portion of an embodiment of the invention;

FIG. 5 is a side view of an alternate embodiment of the invention;

FIG. 6 is a diagram of the exhaust and cooling air flow through the alternate embodiment of the invention;

FIG. 7 is an end view illustrating the outlet portion of an alternate embodiment of the invention; and

FIG. 8 is an end view illustrating the inlet portion of an alternate embodiment of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

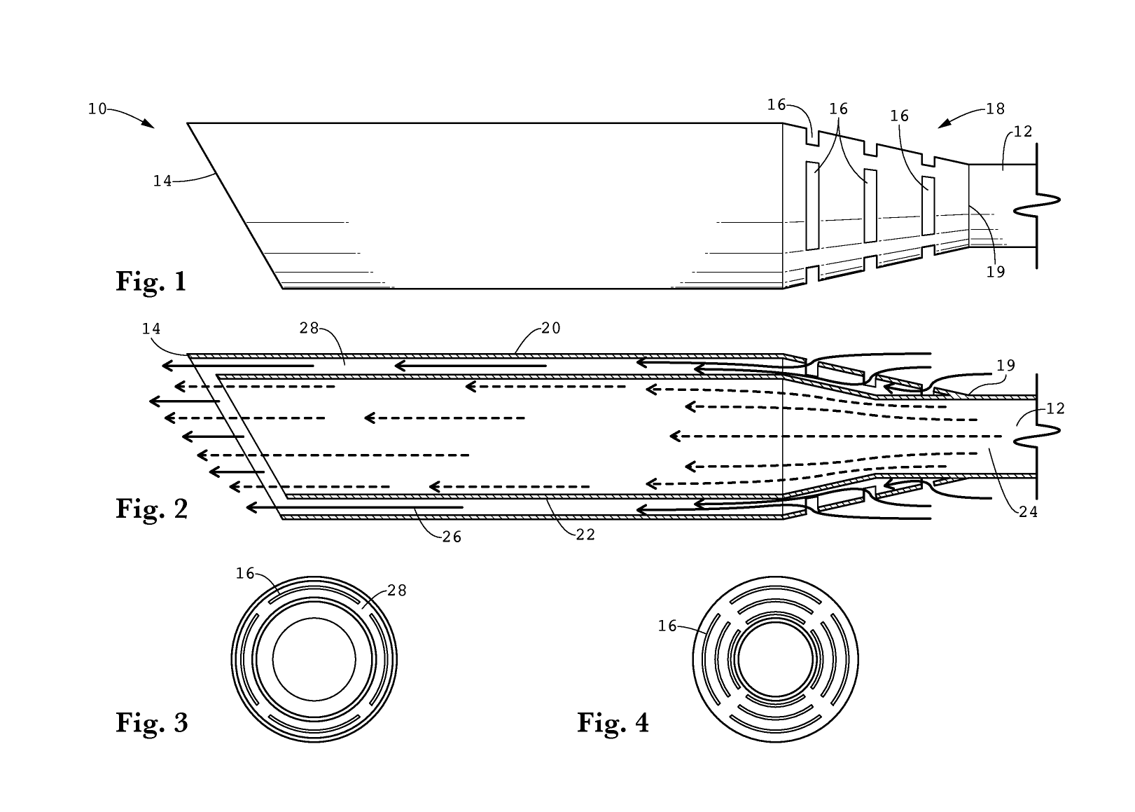

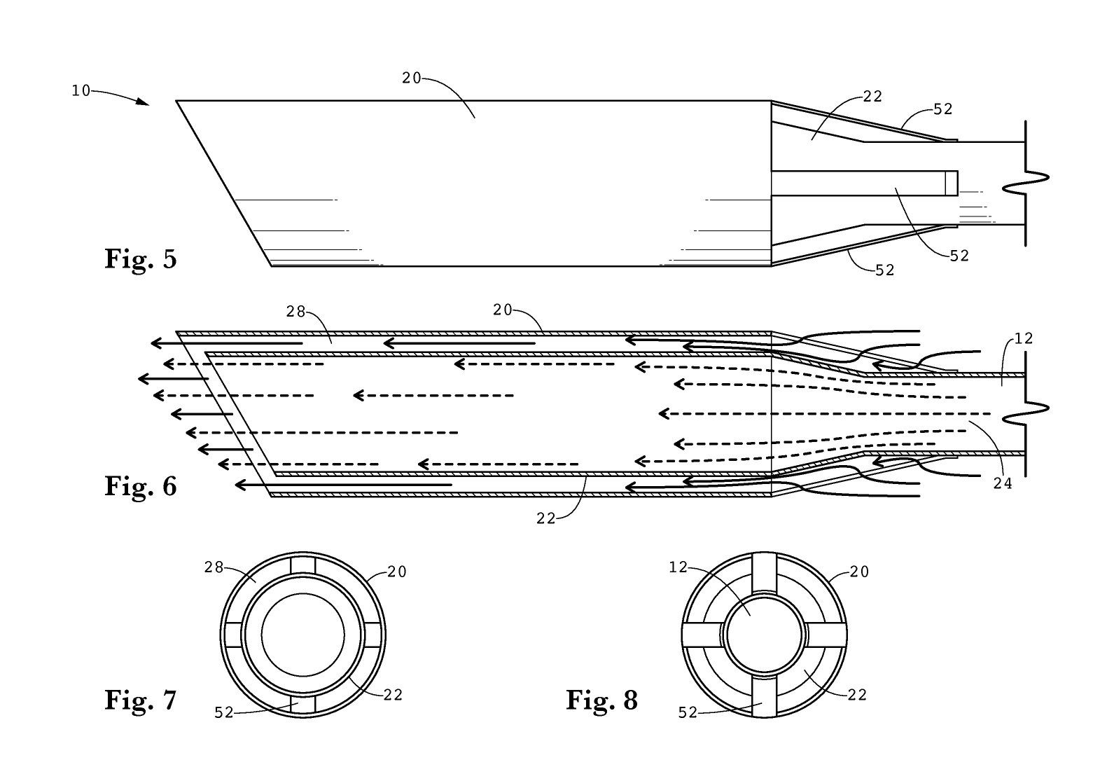

FIGS. 1 and 5 illustrate exterior views of various embodiments of the invention. An exhaust tip 10 has an inlet portion 12 and an outlet portion 14. When an exhaust tip 10 is affixed to an exhaust system, exhaust gasses may enter the inlet, travel through the exhaust tip, and exit at the outlet portion. Referring to FIG. 2, an outer structure 20 is positioned such that it surrounds an interior structure 22. These inner 22 and outer 20 structures are substantially cylindrical in shape. As is shown, the exterior structure 20 and interior structure 22 may transition from a smaller diameter at the inlet 12 to a larger diameter as at the outlet 14. As illustrated, openings 16 may be formed in the exterior cylindrical structure 20 in an area where the diameter of the cylindrical structure transitions from the smaller inlet diameter to the larger outlet diameter 18. As shown, exhaust gas 24 may enter at the inlet portion 12 and move through the interior structure 22 of the invention to exit at the outlet portion 14. As the exhaust gasses pass over the edge of the inner structure 22, the exhaust gasses draw outside air 26 through the space 28 formed between the inner and outer 20 structure. As this outside air is drawn through the space 28, additional outside air is drawn in through the openings 16 near the inlet portion 12. This outside air serves to carry heat that radiates from the inner structure 22 as the result of the hot exhaust gas 24 flowing through the inner structure.

In a preferred embodiment of the invention, the edge of the inner and outer structures 22 and 20 are aligned such that the there is no offset between the edge of each cylindrical structure. Such an arrangement may serve to limit the outer structure's 20 exposure to hot exhaust gasses. In certain embodiments of the invention, the edge of the inner structure 22 is offset to be slightly 30 inside the outer structure 20 such that the flow of exhaust gas serves to draw the outside air through the space 28 between the inner and outer cylindrical structures 22 and 20. The amount of space 28 between the inner and outer cylindrical structures may vary according to the diameter of the inner and outer cylindrical structures but a dimension of ¼ inch has been found to be effective for the purposes of outside air movement through the space 28 that is sufficient to cool the outside cylindrical structure. FIG. 3 illustrates such a space 28 as viewed from the outlet portion 14 of the invention. Also visible are openings 16 which serve to permit outside air to flow into the space 28 between the inner and outer structures 20 and 22. FIG. 4 illustrates the openings 16 as viewed from the inlet end 12 of the illustrated embodiment of the invention. Certain embodiments may have greater or fewer openings than are illustrated in FIG. 4.

As was noted above, in embodiments of the invention, the outside air flow that passes through the space 28 between the inner 22 and outer 20 structures serves to maintain the surface temperature of the outer structure 20 at a point low enough that decorative paint or vinyl decorative layers may be applied to the outer surface of the outer structure without risk of damage from the heat generated by the hot exhaust gasses 24. In such a manner, the appearance of the invention may be customized with a variety of decorative materials.

In addition to embodiments with openings 16 as illustrated in FIGS. 1-4, other embodiments of the invention may use elongated tabs 52 as illustrated in FIGS. 5-8. As shown, the tabs 52 serve to position the outer 20 and inner 22 structures in the proper alignment such that the space 28 between the outer and inner cylindrical structures is not disturbed by vehicle movement. As illustrated in FIG. 6, the exhaust gas 24 flows within the inner cylindrical structure in the same manner as illustrated in the embodiment of the invention shown in FIG. 2. FIG. 7 illustrated a view of the output end of en embodiment of the invention configured using tabs 52 as is illustrated in FIG. 5. FIG. 8 illustrates a view from the input end of an embodiment of the invention showing the exhaust input, the tabs, and the internal cylindrical structure.

In embodiments of the invention, the outer cylindrical structure may be welded, crimped, or other wise secured to the inner structure where the outer cylindrical structure 20 and the inner cylindrical structure 22 are in contact 19.

The embodiments illustrated in FIGS. 1-8 are shown with a slanted opening on the outlet portion of the embodiment. Other embodiments of the invention may use outlets that are cut straight across or cut at a bevel according to the preference of the user who may install the exhaust tip on a vehicle. Embodiments of the invention may be sized such that the inlet portion of the exhaust tip 10 may be positioned over an existing exhaust outlet and then clamped or welded in place.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. An exhaust system tip comprising:
an inner cylindrical structure;
an outer cylindrical structure located coaxially to the inner cylindrical structure;
a coaxial space formed between the inner and outer structures;
an attachment means affixing the inner and outer cylinder structures; and
a plurality of apertures formed in the outer cylinder structure.

2. The exhaust system tip of claim 1, wherein the plurality of openings are locating in a portion of the outer cylinder structure adjacent to the attachment means.

3. The exhaust system tip of claim 1, wherein the coaxial space formed between the inner and outer cylinder is within the range of 0.1 inch and 0.75 inch.

4. The exhaust system tip of claim 1, wherein the coaxial space formed between the inner and outer cylinder is substantially equal to 0.25 inch.

5. The exhaust system tip of claim 1, wherein the inner and outer cylinder structures comprise a portion which increases in diameter from a first dimension at an input to a second dimension at an output of the exhaust tip.

6. The exhaust system tip of claim 5, wherein the inner and outer cylinder structures are substantially parallel.

7. The exhaust system tip of claim 1, wherein:
an end of the inner cylinder structure and an end of the outer cylinder structure comprise an exit portion;
wherein the inner and outer structure each comprise an edge; and
said edges are aligned such that they are substantially parallel.

8. The exhaust system tip of claim 7, wherein said edges are formed such that they are form an angle substantially equal to 90 degrees from the external surface of the outer cylinder structure.

9. The exhaust system tip of claim 7, wherein said edges are formed such that they form an angle less than 90 degrees from the external surface of the outer cylinder structure.

10. The exhaust system tip of claim 1, further comprising a material layer applied to an exterior surface of the outer cylinder structures, said material layer comprising a color or pattern.

11. The exhaust system of claim 10, wherein said material layer is a vinyl material adhered to the exterior surface of the outer cylinder structure.

12. A method of forming an exhaust tip comprising the steps of:
obtaining an inner cylindrical structure;
obtaining an outer cylindrical structure;
positioned the inner and outer cylindrical structures such that they are oriented coaxially to each other and a coaxial space formed between the inner and outer structures;
affixing the inner and outer cylinder structures to one another; and
forming a plurality of apertures in the outer cylinder structure.

13. The method of claim 12, wherein the formed openings are located at a portion of the outer cylinder structure that is forming an increasing diameter of the outer cylinder structure.

14. The method of claim 12, wherein the coaxial space formed is within the range of 0.1 inch to 0.75 inches.

15. The method of claim 12, wherein the inner and outer cylindrical structures are oriented such that they form a coaxial space substantially equal to 0.25 inches between said inner and outer cylindrical structures.

16. The method of claim 12, wherein the inner and outer cylindrical structures are positioned such that they are substantially parallel to one another.

17. The method of claim 12, wherein a coating is applied to the outer cylinder structure to produce an image on the outer cylinder structure.

18. An exhaust system tip comprising:
an inner cylindrical structure;
an outer cylindrical structure positioned coaxially to the inner cylindrical structure;
a coaxial space formed between the inner and outer structures that is in the range of 0.1 inch and 0.75 inch;
an attachment means affixing the inner and outer cylinder structures;
a plurality of apertures formed in the outer cylinder structure in a location adjacent to the attachment means; and
said inner and outer cylinder comprise edges which are aligned at an exit end of the exhaust tip.
